(19) United States
(12) Patent Application Publication
(10) Pub. No.: US 2026/0182782 A1
(43) Pub. Date: Jul. 2, 2026

(54) TITANIUM MATERIAL, TITANIUM CONTAINER, AND METHOD OF MANUFACTURING TITANIUM MATERIAL

(71) Applicant: SUS Inc., Tsubame-shi, Niigata (JP)

(72) Inventors: Akie SHIBUKI, Tsubame-shi, Niigata (JP); Tomoyuki HOMMA, Nagaoka-shi, Niigata (JP)

(73) Assignee: SUS Inc., Tsubame-shi, Niigata (JP)

(21) Appl. No.: 18/855,455

(22) PCT Filed: Sep. 29, 2023
(86) PCT No.: PCT/JP2023/035811

§ 371 Date: Oct. 9, 2024

(30) Foreign Application Priority Data
Aug. 1, 2023 (JP) 2023-125440

(51) Int. Cl. A47J 41/02; C22C 14/00; C22F 1/18; C23C 8/20

(52) U.S. Cl. CPC A47J 41/028; C22C 14/00; C22F 1/183; C23C 8/20

(57) ABSTRACT

An innovative titanium material, titanium container, and method of manufacturing a titanium material are provided. A titanium material having a titanium carbide layer on a surface, wherein the titanium carbide layer has a thickness of 5 μm or greater and a surface arithmetic mean roughness (Ra) of 0.90 μm or greater, and an average of an equivalent circle diameter of an area in which twins are aligned in a crystal grain including said twins, which are confirmed when the surface of the titanium carbide layer is observed under an optical microscope, is 563.7 μm or greater.

### TECHNICAL FIELD

The present invention relates to a titanium material, titanium container, and method of manufacturing a titanium material.

### BACKGROUND ART

The present applicant has filed patent applications related to a vacuum-insulated double-walled container made of titanium, as disclosed in, e.g., Patent Document 1.

### PRIOR ART DOCUMENTS

[Patent Document 1] Japanese Patent No. 5297436

### DISCLOSURE OF THE INVENTION

### Problems that the Invention is to Solve

As a result of further research and development by the present inventors, the present invention was perfected upon discovering the conditions under which the surface of the titanium material is less shiny and less prone to fingerprint stains, and presents a grayish, elegant texture. Therefore, an object of the present invention is to provide an innovative titanium material, titanium container, and method of manufacturing a titanium material.

### Means of Solving the Problems

The main points of the present invention are described below with reference to the attached drawings.

A first aspect of the present invention relates to a titanium material having a titanium carbide layer on a surface, the titanium material characterized in that
the titanium carbide layer has a thickness of 5 μm or greater and a surface arithmetic mean roughness (Ra) of 0.90 μm or greater, and
an average of an equivalent circle diameter of an area in which twins are aligned in a crystal grain including said twins, which are confirmed when the surface of the titanium carbide layer is observed under an optical microscope, is 563.7 μm or greater.

A second aspect of the present invention relates to the titanium material of the first aspect, characterized in that the titanium carbide layer has a thickness of 10 μm or greater.

A third aspect of the present invention relates to the titanium material of the first aspect, characterized in that the titanium carbide layer has a surface arithmetic mean roughness (Ra) of 1.70 μm or greater.

A fourth aspect of the present invention relates to the titanium material of the second aspect, characterized in that the titanium carbide layer has a surface arithmetic mean roughness (Ra) of 1.70 μm or greater.

A fifth aspect of the present invention relates to the titanium material of any of the first to fourth aspects, characterized in that the titanium carbide layer has an average of an equivalent circle diameter of 575.4 μm or greater in an area in which the twins are aligned in a crystal grain.

A sixth aspect of the present invention relates to a titanium container using the titanium material of any of the first to fourth aspects, characterized in having the titanium carbide layer on an outer surface.

A seventh aspect of the present invention relates to a titanium container using the titanium material of the fifth aspect, characterized in having the titanium carbide layer on an outer surface.

An eighth aspect of the present invention relates to a method of manufacturing a titanium material having a titanium carbide layer on a surface, characterized in comprising:
a first heat treatment step of vacuum heating a titanium material in an atmosphere in which carbon is present at a first temperature at which titanium transitions from an α phase to a β phase, and then cooling the titanium material to less than the first temperature; and
after the first heat treatment step, a polishing step of polishing a surface of the titanium material.

A ninth aspect of the present invention relates to the method of manufacturing a titanium material of the eighth aspect, characterized in comprising, after the polishing step, a second heat treatment step of vacuum heating the titanium material at a second temperature at which the titanium transitions from the α phase to the β phase when accommodated in a lidded container or in a carbon-free atmosphere, and then cooling the titanium material to less than the second temperature.

A tenth aspect of the present invention relates to the method of manufacturing a titanium material of the ninth aspect, characterized in that the vacuum heating in the first heat treatment step and the second heat treatment step is performed for 15 to 40 minutes.

An eleventh aspect of the present invention relates to the method of manufacturing a titanium material of any of the eighth to tenth aspects, characterized in that, after the first heat treatment step and prior to the polishing step, the first heat treatment step is repeated one or more times.

A twelfth aspect of the present invention relates to the method of manufacturing a titanium material of any of the eighth to tenth aspects, characterized in that the titanium material is a container, and the heat treatment steps are performed by placing the container on a flat surface so that the opening is facing down to close off said opening.

A thirteenth aspect of the present invention relates to the method of manufacturing a titanium material of the eleventh aspect, characterized in that the titanium material is a container, and the heat treatment steps are performed by placing the container on a flat surface so that the opening is facing down to close off said opening.

### Effect of the Invention

The present invention has the above-described configuration, and is therefore an innovative titanium material, titanium container, and method of manufacturing titanium material.

### BRIEF DESCRIPTION OF THE DRAWINGS

FIG. 1 is a schematic descriptive cross-sectional view of the present embodiment;

FIG. 2 is a step table comparison of a comparative example and an experimental example;

FIG. 3 is a comparative photograph of the external appearance of a comparative example and an experimental example;

FIG. 4 is a result of an X-ray diffraction measurement of a comparative example and an experimental example;

FIG. 5 is an enlarged drawing along the broken line in FIG. 4; and

FIG. 6 is a photograph showing an example of a colony of a comparative example and an experimental example.

### BEST MODE FOR CARRYING OUT THE INVENTION

Embodiments of the present invention considered to be advantageous are briefly described below with reference to the drawings while indicating the effects of the present invention.

The titanium material according to the present invention can be used in, e.g., a titanium container, and in which cases, e.g., the outer surface of the container can be made less shiny and less prone to fingerprint stains, and present a grayish, elegant texture.

In other words, as shall be described in further detail below, it could be confirmed that when the thickness of a titanium carbide layer is 5 μm or greater, the surface arithmetic mean roughness (Ra) is 0.90 μm or greater, and an average of an equivalent circle diameter of an area in which twins are aligned is 563.7 μm or greater, the surface structure is made less shiny (assumes a matte texture) and less prone to fingerprint stains, and furthermore presents a grayish tone.

The manufacturing method disclosed in Patent Document 1 presents problems in terms of low reproducibility, inconsistent quality, and low yield, but the present inventors have found a manufacturing method that can produce the above-described titanium material with good reproducibility.

### Embodiment

A specific embodiment of the present invention is described below on the basis of the drawings.

The present embodiment is a titanium container having a titanium carbide layer on the outer surface.

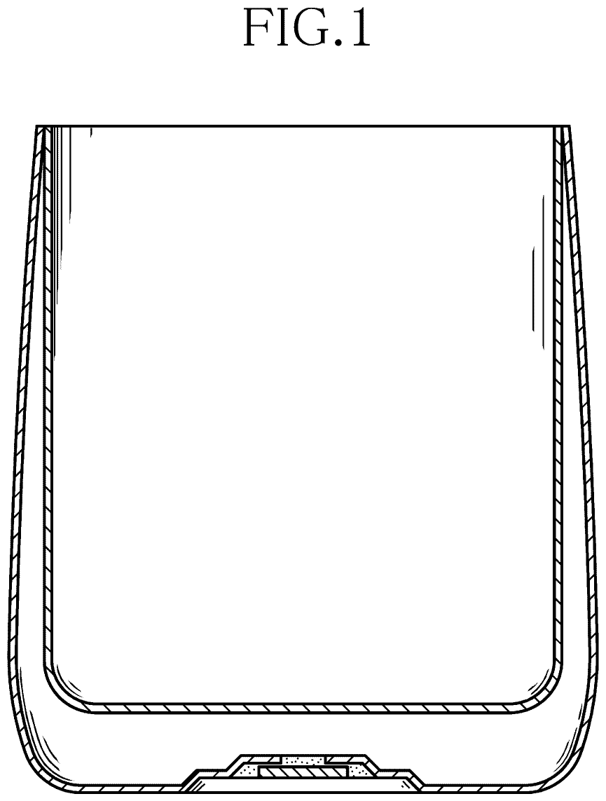

Specifically, as shown in FIG. 1, the present embodiment is a vacuum-insulated double-walled container (tumbler) used for holding a beverage, and is composed of a bottomed cylindrical outer cylinder 1 and a bottomed cylindrical inner cylinder 2 arranged inside the outer cylinder 1. The space between the outer cylinder 1 and the inner cylinder 2 is a vacuum-insulated space. In the drawing, reference numeral 3 is a brazing material (titanium brazing) for sealing, and reference numeral 4 is a sealing plate.

A titanium carbide layer is provided at least to the outer surface of the double-walled container (outer cylinder 1).

The titanium carbide layer has a thickness of 5 μm or greater and a surface arithmetic mean roughness (Ra) of 0.90 μm or greater, and an average of an equivalent circle diameter is 563.7 μm or greater in an area (colony) in which twins are aligned in a crystal grain including said twins, which are confirmed when the surface of the titanium carbide layer is observed under an optical microscope.

The double-walled container according to the present embodiment can be manufactured by performing a prescribed process performed on the outer cylinder 1 and inner cylinder 2, which are made of an industrially pure titanium material (having, e.g., a chemical composition belonging to JIS Class 1). Specifically, the following steps A through E can be performed in sequential fashion for the outer cylinder 1 and inner cylinder 2, which are welded together at the open end side to form a single unit.

Step A: The double-walled container is placed in a vacuum furnace that has a heating function to perform a vacuum-sealing process.

Specifically, a double-walled container with the mouth part joined by welding is placed on a flat surface with the opening facing down (so as to close off the opening). Brazing material 3 is placed around a degassing port 5 at the bottom portion of the outer cylinder 1 and a sealing plate 4 is placed over the brazing material 3, in which state the double-walled container is accommodated in a lidded container (made of stainless steel), and the lidded container is placed inside a vacuum oven. In similar fashion to the known method disclosed in Patent Document 1, etc., the vacuum furnace is heated and the pressure is reduced, the space between the outer cylinder 1 and inner cylinder 2 is degassed, and the brazing material 3 is melted, whereby the space is sealed in a vacuum state by the brazing material 3 and the sealing plate 4, forming a vacuum-insulated space. A cooling treatment is thereafter performed.

The vacuum inside the vacuum furnace during treatment is about 10⁻³ to 10⁻⁴ Torr, the heating temperature (about 1050° C. in the present embodiment) is higher than the temperature (about 880° C.) at which titanium transitions from the α phase to the β phase, and the heating time is about 15 to 40 minutes. Cooling is performed by stopping heating and allowing the temperature to drop below 700° C. by natural cooling, then introducing nitrogen gas into the furnace to restore normal pressure and cool to room temperature.

The container is heated to the temperature at which titanium transitions from the α phase to the β phase or higher, and is cooled to less than said temperature to form ceramic-like irregularities on the container surface and produce a unique appearance. The entire double-walled container is nitrided by nitrogen gas. The reason for accommodating the container in a lidded container during the vacuum sealing process is to prevent degradation of the brazing material due to the nitrogen gas. Therefore, when a gas that does not degrade the brazing material is used, the treatment may be carried out without placing the container in a lidded container.

Step B: Perform a vacuum heat treatment for titanium carbide layer formation.

This vacuum heating process is performed with the double-walled container exposed to a furnace atmosphere where carbon is present without being accommodated in a lidded container (as in Step A, the double-walled container is placed on a flat surface so that the opening is facing down to close off the opening.).

For example, carbon powder is distributed in the vacuum furnace, a small amount of carbon gas is introduced, or other appropriate means is used to create an atmosphere in the furnace during heating in which carbon is present, and the vacuum furnace is heated, depressurized, and then cooled. The degree of vacuum, heating temperature, and heating time are the same as in Step A, and cooling is also performed in the same manner as in Step A.

In the vacuum heating treatment, titanium transitions from the α phase (hcp structure) to the β phase (bcc structure) and back to the α phase (hcp structure), and in this process, carbon atoms in the atmosphere enter voids in the bcc structure when the dense hcp structure is replaced by the sparse bcc structure, and the carbon atoms that have entered the bcc structure are pushed out when the structure returns to the hcp structure again. The carbon atoms that have been pushed out accumulate on the surface (outer surface of the outer cylinder 1 exposed to the carbon atmosphere) to form a titanium carbide layer.

Step C: The same vacuum heating treatment as in Step B is performed one or more times as necessary (once in the present embodiment).

Step D: A polishing treatment is performed on the outer surface of the double-walled container.

Specifically, the outer surface is polished by a lathing machine using a polishing material.

Performing a polishing treatment makes it possible to manufacture, with good reproducibility (high yield), a titanium container with a unique texture in which irregularities are formed the surface (The manufacturing method of Patent Document 1 does not have a polishing step and differs from the present embodiment on this point.).

Step E: The vacuum heating step is performed with the double-walled container stored in a lidded container (as in step A, etc., the container is placed on a flat surface with the opening facing down to close off the opening). The reason for placing the double-walled container in the lidded container is to perform the vacuum heating treatment in an atmosphere where as little carbon as possible is present, and when the furnace can be kept in a carbon-free atmosphere, the double-walled container can be treated without being placed in a lidded container.

The vacuum heating treatment further promotes the growth of twins in the interior (twins also grow in Steps B and C), and when the twins thus grown reach the surface, further roughening the surface makes it possible to produce a configuration in which the arithmetic mean roughness (Ra) is 0.90 μm or greater and the average of an equivalent circle diameter of the colonies is 563.7 μm. The degree of vacuum, heating temperature, heating time, and cooling are the same as in Step A, etc. In the present embodiment, the heating temperatures of Steps B and C, and Step E are the same, but they may be different. Similarly, the heating times of Steps B and C, and Step E may be different.

The above Steps A to E make it possible to produce a vacuum-insulated double-walled container made of titanium with the above configuration. Although the present embodiment describes a titanium container, the present invention is not limited to containers, and can be applied to other titanium products as well, such as when a titanium carbide layer is provided on the main (largest) surface of a plate material.

Although it is possible to produce a titanium container with a unique texture with good reproducibility if at least Steps A, B, and D are performed, it was confirmed that by performing the step for the formation of the titanium carbide layer (performing Step C) a plurality of times, and performing Step E for promoting the growth of twins in addition to Step A, B, and D, it is possible to achieve a more tactile sensation and matte texture, and a grayish appearance.

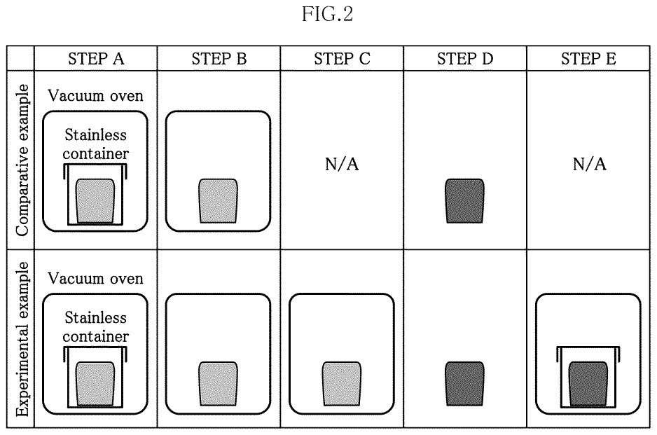

Specifically, a comparative example produced by performing the above-described steps A, B, and D in sequence (without Steps C and E) was compared with an experimental example produced by performing the above-described Steps A through E in sequence, as shown in FIG. 2.

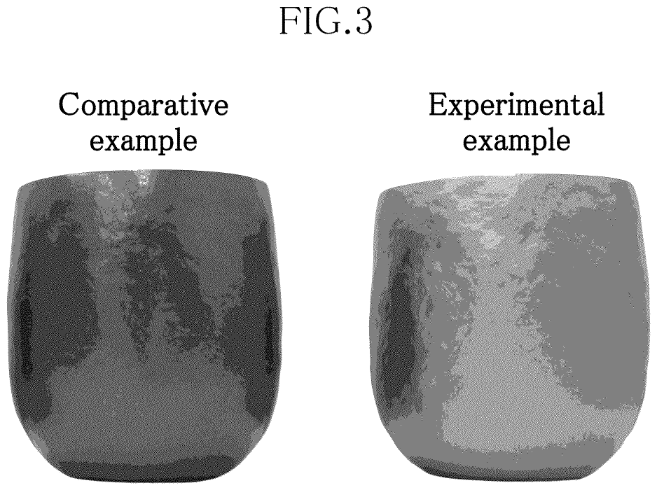

FIG. 3 is a photograph of the external appearance of the comparative example and the experimental example. It can be confirmed that the experimental example is less shiny than the comparative example and has a grayish tone rather than a black color. It is also confirmed that fingerprints are less likely to adhere (less noticeable) than in the comparative example.

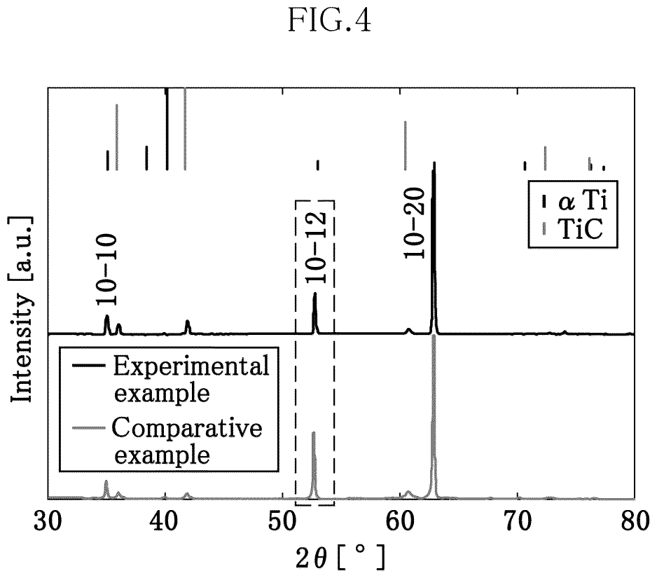

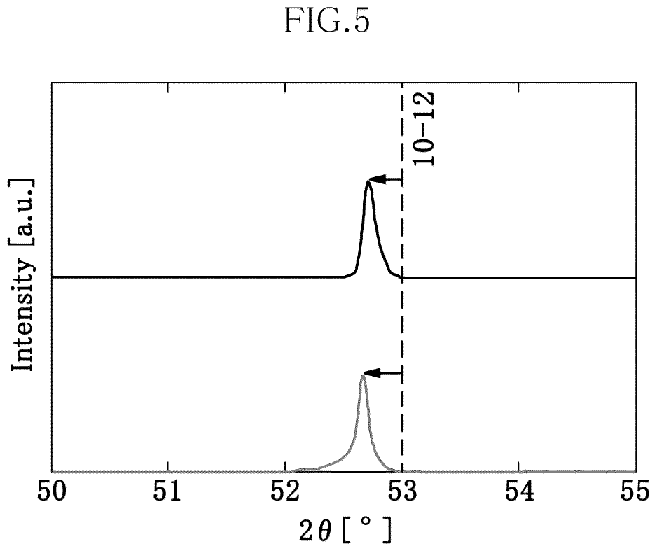

FIGS. 4 and 5 show the results of X-ray diffraction measurements of the comparative example and the experimental example. A titanium carbide layer is thereby formed on the surface (outer surface of the outer cylinder 1), and the peak corresponding to the [10-12] plane has shifted to the left (see FIG. 5). It can therefore be confirmed that a twin is generated on the [10-12] plane. The thickness of the titanium carbide layer in the comparative example is about 5 μm, and the thickness of the titanium carbide layer in the experimental example is about 10 μm. Hue varies with the thickness of the titanium carbide layer on the surface, and surface roughness varies with the degree of twin growth, but it is found that, in the experimental example, the titanium carbide layer is increased in thickness by Step C, and twin growth is increased by Step E, thereby making the hue, matte texture, and tactile sensation to be more advantageous.

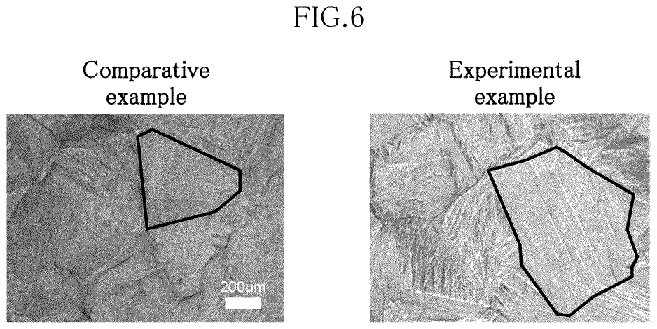

Table 1 show the measurement results of colony size for the comparative and experimental examples, and Table 2 shows the measurement results of surface roughness (arithmetic mean roughness (Ra)). The area of colonies in a 3×7-mm sample that area visible under an optical microscope was calculated using image processing software and converted to an equivalent circle diameter (diameter of an area replaced by a perfect circle with the same area), and the average values and the like were calculated. FIG. 6 shows an example of a colony observed under an optical microscope (In FIG. 6, the magnification factor is the same for the comparative and experimental examples). The surface roughness was measured by a surface roughness measuring machine (SURFCOM 1500DX 3DF) manufactured by ACCRETECH (Tokyo Seimitsu) in accordance with JIS B0633 (2001). The measurement conditions were as follows: measurement length: 4.0 mm, reference length (cutoff value): 0.8 mm, measurement magnification: 2000 times, probe radius: 2 μm, measurement speed: 0.3 mm/s, cutoff type: Gaussian, and slope correction: least-squares linear correction. The “rolled material” in the table indicates the equivalent circular diameter and surface roughness of a rolled material (plate material) of pure titanium for industrial use before being processed into cylindrical shape.

TABLE 1

| | Average | Maximum | Minimum | Standard |
|---|---|---|---|---|
| | diameter | diameter | diameter | deviation |
| | [μm] | [μm] | [μm] | [μm] |
| Comparative | 563.7 | 1168.4 | 126.8 | 221.4 |
| example | | | | |
| Experimental | 575.4 | 1024.1 | 238.2 | 235.7 |
| example | | | | |
| Rolled | 14.0 | 22.9 | 6.0 | 3.7 |
| material | | | | |

TABLE 2

| | Arithmetic mean |
|---|---|
| | roughness Ra [μm] |
| Comparative | 0.90 |
| example | |
| Experimental | 1.70 |
| example | |
| Rolled | 0.59 |
| material | |

From the above comparison, it can be confirmed that the comparative example and the experimental example have an increased equivalent circle diameter and Ra in comparison with the rolled material, and the experimental example has an increased equivalent circle diameter (average diameter) and Ra in comparison with the comparative example. Although the average diameter (563.7 μm) and Ra (0.90 μm) of the colonies in the comparative example also result in a desirable appearance, it is found that when the values in the comparative example are exceeded (e.g., the average diameter of the colonies in the experimental example being 575.4 μm, and Ra being 1.70 μm), an even better appearance is obtained, and steps C and E are considered necessary to obtain the values in the experimental example.

Having the configuration as described above, the present embodiment yields an innovative titanium container that is less shiny and less prone to fingerprint stains, and has a grayish, elegant texture.

1-13. (canceled)

14. A titanium material having a titanium carbide layer on a surface, said titanium material characterized in that
the titanium carbide layer has a thickness of 5 μm or greater and a surface arithmetic mean roughness (Ra) of 0.90 μm or greater, and
an average of an equivalent circle diameter of an area in which twins are aligned in a crystal grain including said twins, which are confirmed when the surface of the titanium carbide layer is observed under an optical microscope, is 563.7 μm or greater.

15. The titanium material according to claim 14, characterized in that the titanium carbide layer has a thickness of 10 μm or greater.

16. The titanium material according to claim 14, characterized in that the titanium carbide layer has a surface arithmetic mean roughness (Ra) of 1.70 μm or greater.

17. The titanium material according to claim 15, characterized in that the titanium carbide layer has a surface arithmetic mean roughness (Ra) of 1.70 μm or greater.

18. The titanium material according to claim 14, characterized in that the titanium carbide layer has an average of an equivalent circle diameter of 575.4 μm or greater in an area in which the twins are aligned in a crystal grain.

19. A titanium container using the titanium material according to claim 14, characterized in having the titanium carbide layer on an outer surface.

20. The titanium container using the titanium material according to claim 18, characterized in having the titanium carbide layer on the outer surface.

21. A method of manufacturing a titanium material having a titanium carbide layer on a surface, characterized in comprising:
a first heat treatment step of vacuum heating a titanium material in an atmosphere in which carbon is present at a first temperature at which titanium transitions from an α phase to a β phase, and then cooling the titanium material to less than the first temperature;
after the first heat treatment step, a polishing step of polishing a surface of the titanium material; and
after the polishing step, a second heat treatment step of vacuum heating the titanium material at a second temperature at which the titanium transitions from the α phase to the β phase when accommodated in a lidded container or in a carbon-free atmosphere, and then cooling the titanium material to less than the second temperature.

22. The method of manufacturing a titanium material according to claim 21, characterized in that the vacuum heating in the first heat treatment step and the second heat treatment step is performed for 15 to 40 minutes.

23. The method of manufacturing a titanium material according to claim 21, characterized in that the titanium material is a container, and the heat treatment steps are performed by placing the container on a flat surface so that the opening is facing down to close off said opening.

24. The method of manufacturing a titanium material according to claim 22, characterized in that the titanium material is a container, and the heat treatment steps are performed by placing the container on a flat surface so that the opening is facing down to close off said opening.

25. A method of manufacturing a titanium material having a titanium carbide layer on a surface, characterized in comprising:
a first heat treatment step of vacuum heating a titanium material in an atmosphere in which carbon is present at a first temperature at which titanium transitions from an α phase to a β phase, and then cooling the titanium material to less than the first temperature;
after the first heat treatment step, a polishing step of polishing a surface of the titanium material; and
further characterized in that the titanium material is a container, and the heat treatment steps are performed by placing the container on a flat surface so that the opening is facing down to close off said opening.

26. The method of manufacturing a titanium material according to claim 21, characterized in that, after the first heat treatment step and prior to the polishing step, the first heat treatment step is repeated one or more times.
